(19) United States
(12) Patent Application Publication
(10) Pub. No.: US 2023/0394842 A1
(43) Pub. Date: Dec. 7, 2023

(54) VISION-BASED SYSTEM WITH THRESHOLDING FOR OBJECT DETECTION

(71) Applicant: Tesla, Inc., Austin, TX (US)

(72) Inventors: Chen Meng, Austin, TX (US); Tushar T. Agrawal, Austin, TX (US)

(21) Appl. No.: 18/321,550

(22) Filed: May 22, 2023

Related U.S. Application Data
(60) Provisional application No. 63/365,078, filed on May 20, 2022.
(60) Provisional application No. 63/365,119, filed on May 20, 2022.

(51) Int. Cl. G06V 20/56; G06T 5/50

(52) U.S. Cl. CPC G06V 20/56; G06T 2207/20221; G06V 2201/07; G06T 5/50

(57) ABSTRACT

A vehicle may obtain a set of data corresponding to operation of the vehicle, wherein the set of data includes a set of images corresponding to a vision system. A vehicle may process individual image data from the set of images to determine whether object detection is depicted in the individual image data. A vehicle may update object information corresponding to a sequence of processing results based on the processing of the individual image data. A vehicle may determine whether the updated object information satisfies at least one threshold. A vehicle may identify a detected object and associated object attributes based on the determination that the updated object information satisfies the at least one threshold.

### CROSS-REFERENCE TO RELATED APPLICATIONS

This application claims priority to U.S. Prov. Patent App. No. 63/365119 titled “VISION-BASED SYSTEM WITH THRESHOLDING FOR OBJECT DETECTION” and filed on May 20, 2022. This application additionally claims priority to U.S. Prov. Patent App. No. 63/365078 titled “VISION-BASED MACHINE LEARNING MODEL FOR AUTONOMOUS DRIVING WITH ADJUSTABLE VIRTUAL CAMERA” and filed on May 20, 2022. Each of the above-recited applications is hereby incorporated herein by reference in its entirety.

### BACKGROUND

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet).

Generally described, a variety of vehicles, such as electric vehicles, combustion engine vehicles, hybrid vehicles, etc., can be configured with various sensors and components to facilitate operation of the vehicle or management of one or more systems include in the vehicle. In certain scenarios, a vehicle owner or vehicle user may wish to utilize sensor-based systems to facilitate in the operation of the vehicle. For example, vehicles can include hardware and software functionality, including neural networks and/or other machine learning systems, that facilitates autonomous or semi-autonomous driving. For example, vehicles can often include hardware and software functionality that facilitates location services or can access computing devices that provide location services. In another example, vehicles can also include navigation systems or access navigation components that can generate information related to navigational or directional information provided to vehicle occupants and users. In still further examples, vehicles can include vision systems to facilitate navigational and location services, safety services or other operational services/components.

### BRIEF DESCRIPTION OF THE DRAWINGS

FIG. 1A is an illustrative vision system for a vehicle.

FIG. 1B is a block diagram illustrating example processor components for determining object/signal information based on received image information.

FIG. 2A is a block diagram of tracking engine generating tracked objects based on object/signal information.

FIG. 2B illustrates examples of tracking an object at multiple instances.

FIG. 3 is a block diagram illustrating an example process for applying a vulnerable road user network to image information.

FIG. 4 is a block diagram illustrating an example process for applying a non-vulnerable road user network to image information.

FIG. 5 is a block diagram of an example vision-based machine learning model used in combination with a super narrow machine learning model.

FIG. 6 is a flowchart of an example process for applying thresholds to detected objects.

FIG. 7 is a block diagram illustrating an example environment that utilizes vision-only detection systems.

FIG. 8 is a block diagram illustrating an example architecture for implementing the vision information processing component.

### DETAILED DESCRIPTION

### Introduction

This application describes enhanced techniques for object detection using image sensors (e.g., cameras) positioned about a vehicle. The enhanced techniques can be implemented for autonomous or semi-autonomous (collectively referred to herein as autonomous) driving of a vehicle. Thus, the vehicle may navigate about a real-world area using vision-based sensor information. As may be appreciated, humans are capable of driving vehicles using vision and a deep understanding of their real-world surroundings. For example, humans are capable of rapidly identifying objects (e.g., pedestrians, road signs, lane markings, vehicles) and using these objects to inform driving of vehicles. Autonomous driving systems may use various functions to detect objects to inform the control of the autonomous vehicle.

Traditionally, vehicles are associated with physical sensors that can be used to provide inputs to control components. Many autonomous driving, navigational, locational and safety systems, use detection-based systems with physical sensors configured for detection systems, such as radar systems, LIDAR systems, SONAR systems, and the like, that can detect objects and characterize attributes of the detected objects. The use of detection-based systems can increase the cost of manufacture and maintenance and add complexity to the machine learning models. Additionally, environmental scenarios, such as rain, fog, snow, etc., may not be well suited for detection-based systems and/or can increase errors in the detection-based systems.

Traditional detection-based system can utilize a combination of detection systems and vision system for confirmation related to the detection of objects and any associated attributes of the detected objects. More specifically, some implementations of a detection-based system can utilize the detection system (e.g., radar or LIDAR) as a primary source of detecting objects and associated object attributes. These systems then utilize vision systems as secondary sources for purposes of confirming the detection of the object or otherwise increasing or supplementing a confidence value associated with an object detected by the detection system. If such confirmation occurs, the traditional approach is to use the detection system outputs as the source of associated attributes of the detected objects. Accordingly, systems incorporating a combination of detection and vision systems do not require higher degrees of accuracy in the vision system for detection of objects.

This application describes a vision-based machine learning model which improves the accuracy and performance of machine learning models, such as neural networks, and can be used to detect objects and determine attributes of the detected objects. Illustratively, the vision-only systems are in contrast to vehicles that may combine vision-based systems with one or more additional sensor systems.

The vision-based machine learning model can generate output identifying objects and associated characteristics. Example characteristics can include position, velocity, acceleration, and so on. With respect to position, the vision-based machine learning model can output cuboids which may represent position along with size (e.g., volume) of an object. These outputs can be then utilized for further processing, such as for autonomous driving systems, navigational systems, locational systems, safety systems and the like.

The above-described objects may need to be tracked over time to ensure that the vehicle is able to autonomously navigate about the objects. For example, these tracked objects may be used downstream by the vehicle to navigate, plan routes, and so on. As may be appreciated, machine learning models may output phantom objects which are not physically proximate to the vehicle. For example, reflections, smoke, fog, lens flares, and so on, may cause phantom objects to be briefly pop into, or out of, detection. The present application describes techniques by which objects may be reliably tracked over time while ensuring that such objects are physically proximate to the vehicle. As will be described, thresholding techniques may be used with respect to the objects detected by the vision-based machine learning model. The utilization of thresholding on the output of the machine learning model can reduce errors, such as missing frames of video data, discrepancies in camera data, false positives, false negatives, and so on. Additionally, the use of thresholding may increase the fidelity of the vision-only systems in low visibility such as during inclement weather or in low light scenarios. Further, the use of thresholding may increase the efficiency of the vision-only system by filtering errors from propagating downstream.

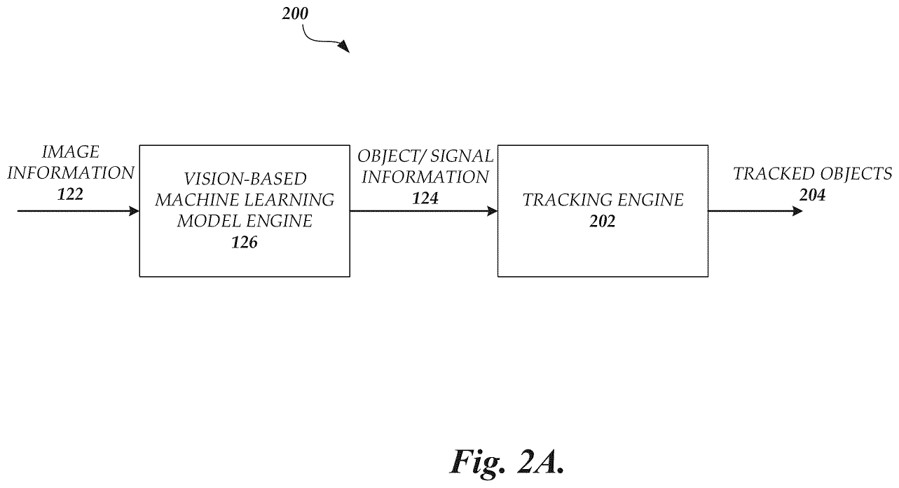

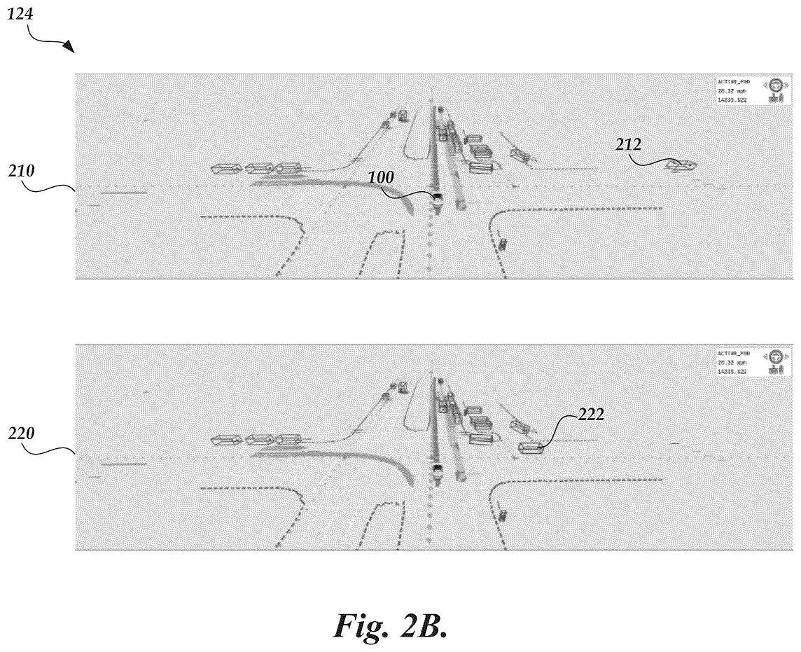

As will be described, the vision-based machine learning model may output representations of detected objects (e.g., cuboids). This output may be generated via forward passes through the machine learning model performed at a particular frequency (e.g., 24 Hz, 30 Hz, 60 Hz, an adjustable frequency). The output may be stored as sequential entries. A tracker, such as the tracker engine 202 in FIG. 2A, may assign unique identifiers to each object and then track them in the sequential entries (e.g., track their positions). The number of sequential entries can be finite in length, such as a moving window of the most recent number of determinations. In one embodiment, during operation, the vision system provides inputs to the machine learning model on a fixed time frame (e.g., every x seconds). Accordingly, in such embodiments, each sequential entry can correspond to a time of capture of image data. Additionally, the finite length can be set to a minimum amount of time (e.g., a number of seconds) determined to have confidence to detect an object using vision data.

The tracker may compare tracked objects against one or more thresholds to determine whether the sequence of entries can be characterized as confirming detection of an object. The thresholds can be specified as a comparison of the total number of “positive” detections (e.g., an object was detected for a particular frame) over the set of entries in the tracking data. The thresholds can be specified as a comparison of the total number of “negative” detections (e.g., an object was not detected for a particular frame) over the set of entries in the tracking data. Additionally, the processing of the system can also require the last entry to be a “positive” and/or a “negative” detection in order to satisfy the thresholds. In some embodiments, different thresholds can be applied, such as for specifying different levels of confidence. If the thresholds are met for a tracked object, the tracker may maintain the object for use in downstream processes. In contrast, if the thresholds are not met, then the tracker may discard the object for use in downstream processes (e.g., filter the objects from a set of tracked objects proximate to the vehicle).

In some embodiments, the use of thresholds can be further used on the different attributes of the tracked objects. The thresholds can be used on the attributes in a similar manner as was performed on the object information. The use of thresholds on attributes can help prevent sudden erroneous changes in that attributes. For example, the use of thresholds may help prevent a car object from suddenly being classified as a minivan object. The thresholds can be specified as a total number of consecutive recorded instances of an attribute required for the attribute to be assigned to the tracked object. For example, the thresholds can require four consecutive classifications that an object is a minivan before the system classifies or reclassifies the object as a minivan.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicles including vehicles with different of propulsion systems, such as combination engines, hybrid engines, electric engines, and the like. Still further, aspects of the present application may be applicable with various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate operation of the vehicle, including autonomous driving applications, driver convenience applications and the like.

Block Diagrams—Vision-Based Machine Learning Model Engine

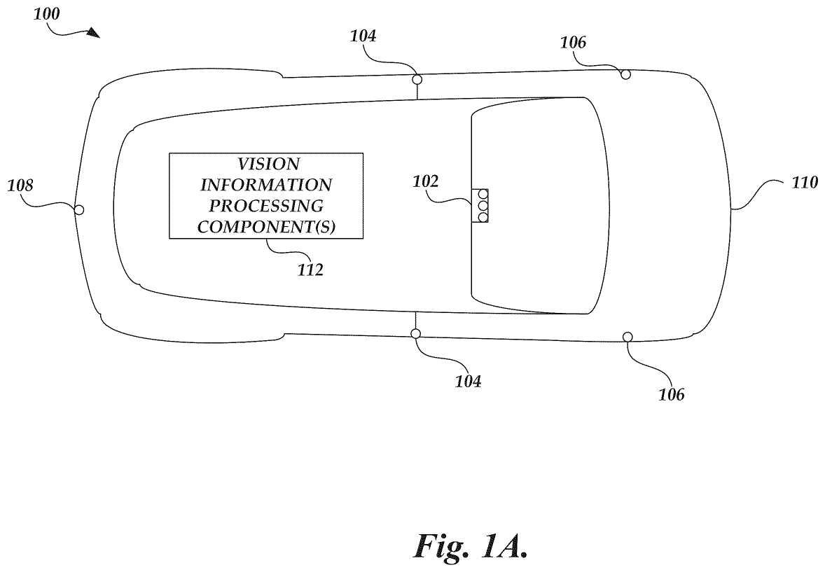

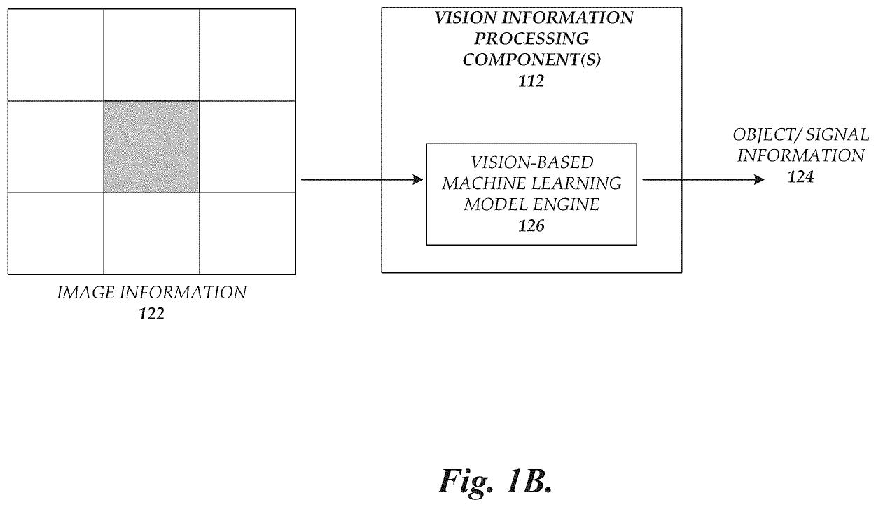

With reference now to FIG. 1A, an illustrative vision system for a vehicle 100 will be described. The vision system includes a set of cameras that can capture image data during the operation of a vehicle. As described above, individual image information may be received at a particular frequency such that the illustrated images represent a particular time stamp of images. In some embodiments, the image information may represent high dynamic range (HDR) images. For example, different exposures may be combined to form the HDR images. As another example, the images from the image sensors may be pre-processed to convert them into HDR images (e.g., using a machine learning model).

As illustrated in FIG. 1A, the set of cameras can include a set of front facing cameras 102 that capture image data. The front facing cameras may be mounted in the windshield area of the vehicle to have a slightly higher elevation. The front facing cameras 102 can including multiple individual cameras configured to generate composite images. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle. The vision system further includes a set of cameras 104 mounted on the door pillars of the vehicle 100. The vision system can further include two cameras 106 mounted on the front bumper of the vehicle 100. Additionally, the vision system can include a rearward facing camera 108 mounted on the rear bumper, trunk or license plate holder.

The set of cameras 102, 104, 106, and 108 may all provide captured images to one or more vision information processing components 112, such as a dedicated controller/embedded system. For example, the vision information processing components 112 may include one or more matrix processors which are configured to rapidly process information associated with machine learning models. The vision information processing components 112 may be used, in some embodiments, to perform convolutions associated with forward passes through a convolutional neural network. For example, input data and weight data may be convolved. The vision information processing components 112 may include a multitude of multiply-accumulate units which perform the convolutions. As an example, the matrix processor may use input and weight data which has been organized or formatted to facilitate larger convolution operations. Alternatively, the image data may be transmitted to a general-purpose processing component.

Illustratively, the individual cameras may operate, or be considered individually, as separate inputs of visual data for processing. In other embodiments, one or more subsets of camera data may be combined to form composite image data, such as the trio of front facing cameras 102. As further illustrated in FIG. 1A, in embodiments related to vehicles incorporating vision only systems, such as vehicles 100, no detection systems would be included at 110.

FIG. 1B is a block diagram illustrating the example processor components 112 determining object/signal information 124 based on received image information 122 from the example image sensors.

The image information 122 includes images from image sensors positioned about a vehicle (e.g., vehicle 100). In the illustrated example of FIG. 1A, there are 8 image sensors and thus 8 images are represented in FIG. 1B. For example, a top row of the image information 122 includes three images from the forward-facing image sensors. As described above, the image information 122 may be received at a particular frequency such that the illustrated images represent a particular time stamp of images. In some embodiments, the image information 122 may represent high dynamic range (HDR) images. For example, different exposures may be combined to form the HDR images. As another example, the images from the image sensors may be pre-processed to convert them into HDR images (e.g., using a machine learning model).

In some embodiments, each image sensor may obtain multiple exposures each with a different shutter speed or integration time. For example, the different integration times may be greater than a threshold time difference apart. In this example, there may be three integration times which are, in some embodiments, about an order of magnitude apart in time. The processor components 112, or a different processor, may select one of the exposures based on measures of clipping associated with images. In some embodiments, the processor components 112, or a different processor may form an image based on a combination of the multiple exposures. For example, each pixel of the formed image may be selected from one of the multiple exposures based on the pixel not including values (e.g., red, green, blue) values which are clipped (e.g., exceed a threshold pixel value).

The processor components 112 may execute a vision-based machine learning model engine 126 to process the image information 122. As described herein, the vision-based machine learning model may combine information included in the images. For example, each image may be provided to a particular backbone network. In some embodiments, the backbone networks may represent convolutional neural networks. Outputs of these backbone networks may then, in some embodiments, be combined (e.g., formed into a tensor) or may be provided as separate tensors to one or more further portions of the model. In some embodiments, an attention network (e.g., cross-attention) may receive the combination or may receive input tensors associated with each image sensor. The combined output, as will be described, may then be provided to different branches which are respectively associated with vulnerable road users (VRUs) and non-VRUs. As described herein, example VRUs may include pedestrians, baby strollers, skateboarders, and so on. Example non-VRUs may include vehicles, such as cars, trucks, and so on.

As illustrated in FIG. 1B, the vision-based machine learning model engine 126 may output object/signal information 124. This object information 124 may include one or more of positions of the objects (e.g., information associated with cuboids about the objects), velocities of the objects, accelerations of the objects, types or classifications of the objects, whether a car object has its door open, and so on.

With respect to cuboids, example object information 124 may include location information (e.g., with respect to a common virtual space or vector space), size information, shape information, and so on. For example, the cuboids may be three-dimensional. Example object information 124 may further include whether an object is crossing into a lane or merging. Pedestrian information (e.g., position, direction), lane assignment information, whether an object is doing a U-turn, stopped for traffic, is parked, and so on.

Additionally, the vision-based machine learning model engine 126 may process multiple images spread across time. For example, video modules may be used to analyze images (e.g., the feature maps produced thereof, for example by the backbone networks or subsequently in the vision-based machine learning model) which are selected from within a prior threshold amount of time (e.g., 3 seconds, 5 seconds, 15 seconds, an adjustable amount of time, and so on). In this way, objects may be tracked over time such that the processor components 112 monitors their location even when temporarily occluded.

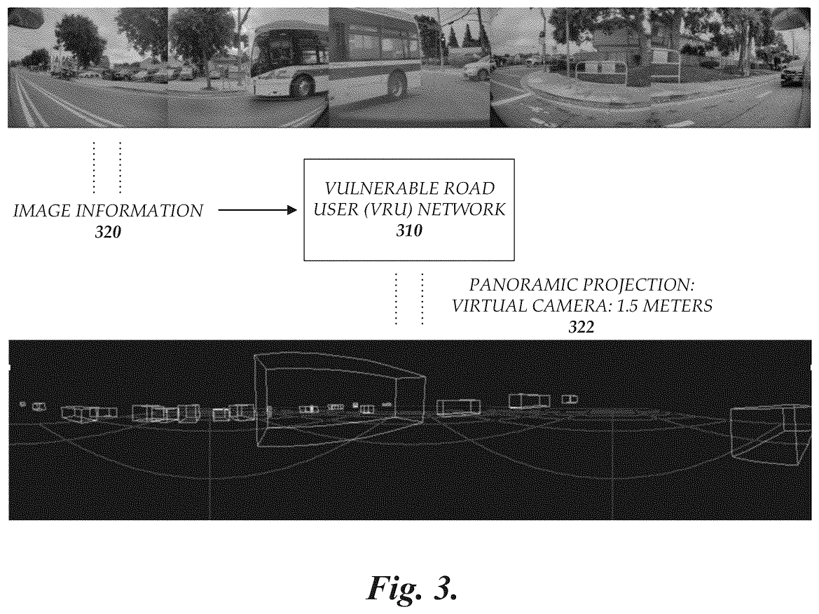

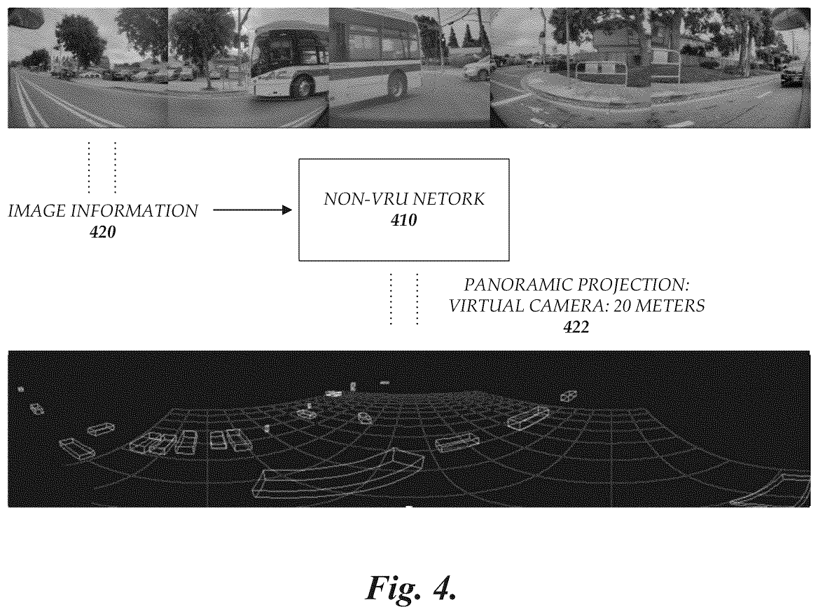

In some embodiments, the vision-based machine learning model engine 126 may output information which forms one or more images. Each image may encode particular information, such as locations of objects. For example, bounding boxes of objects positioned about an autonomous vehicle may be formed into an image. In some embodiments, the projections 322 and 324 of FIGS. 3 and 4 may be images generated by the vision-based machine learning model 126.

Additionally, as will be described, thresholds may be applied on object information. For example, thresholds can be applied to remove one or more detected objects from the output object/signal information 124. Examples of the process of applying thresholds to output information 124 is described below.

Further description related to the vision-based machine learning model engine is included in U.S. Prov. Patent App. No. 63/365078, which has also been converted as U.S. patent application Ser. No. 17/820859, and which is incorporated herein by reference in its entirety.

FIG. 2A is a block diagram illustrating an example environment 200 for applying thresholds on object information 124. As previously described, vision-based machine learning model engine 126 can take image information 122 and output object information 124. Object information 124 can contain cuboid representations of detected objects. Object information 124 may not always perfectly represent the physical surroundings of a the vehicle. Object information 124 can include false detections. For example, object information 124 can include cuboid representations of nonexistent objects. Object information 124 can include false omissions. For example, object information 124 may not have a cuboid representation for all objects within a desired range of the vehicle.

Tracking engine 202 may assign unique identifiers to each object and track them in sequential entries. With respect to a unique identifier, the tracking engine 202 may identify objects which are newly included in the object information 124. As may be appreciated, at each time step or instance (e.g., inference output) the positions of objects may be adjusted. However, the tracking engine 202 may maintain a consistent identification of the objects based on their features or characteristics. For example, the tracking engine 202 may identify a particular object identified in object information 124 for a first-time step or instance. In this example, the tracking engine 202 may assign or otherwise associate a unique identifier with the particular object. At a second-time step or instance, the identify the particular object in the object information 124 based o, for example, its new position being within a threshold distance of a prior position. The identification may also be based on the particular object having the same classification (e.g., van) or other signals or information (e.g., the particular object may have been traveling straight and maintains that direction, the particular object may have been turning right and is maintaining that maneuver). Since object information 124 may be output rapidly (e.g., 24 Hz, 30 Hz, 60 Hz), the tracking engine 202 may be able to reliably assign a same unique identifier to a same unique object. As described above, an object may briefly be classified differently (e.g., a car to a minivan). Similar to the above, the tracking engine 202 may assign the same unique identifier to this object based on its position, signals, and so on.

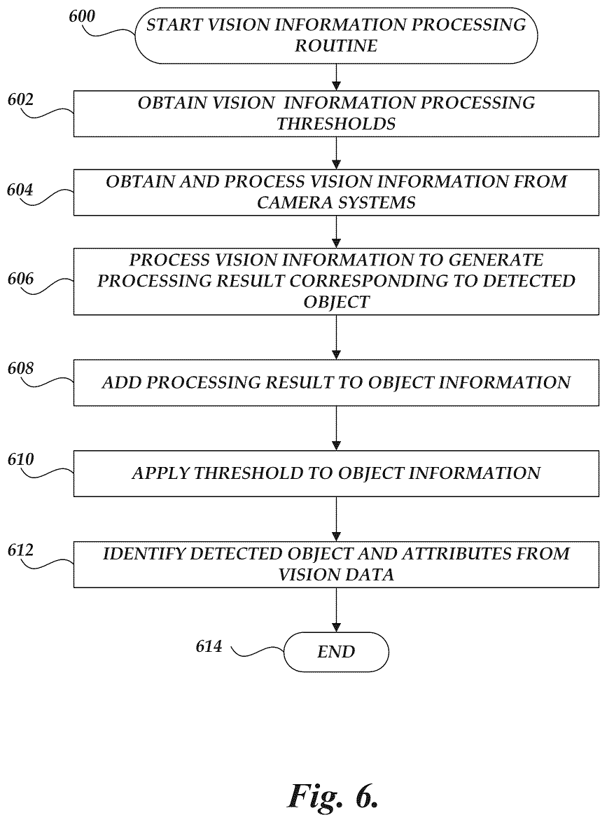

Tracking engine 202 can apply one or more thresholds on the object information 124. The thresholds can compare tracked objects against thresholds to determine whether the sequence of entries can be characterized as confirming detection of an object. The thresholds can operate to filter out erroneous data, such as erroneous detected objects, from object information 124. For example, tracking engine 202 can require a threshold number of “positive” detections of the sequence of entries for an object in the object information 124. As another example, tracking engine 202 can require a threshold number of “negative” detections of the sequence of entries for an object in the object information 124. Tracking engine 202 can apply any of the thresholds described herein, such as were previously described and are described in FIG. 6. If the thresholds are not met, the vision system can return to collecting data and updating the object information.

If the thresholds are met, the object associated with the object information can be output as a tracked object 204. Tracked objects 204 can be used in downstream processes, such as by a planning engine in an autonomous driving system, to make decisions based on object attributes, such as position, rotation, velocity, acceleration, etc. Additionally, the tracking engine 202 can provide the confidence values/categories with the tracked objects.

FIG. 2B is an illustration of object information 124 at a first instance 210 (e.g., a first time stamp or time step associated with output from the engine 126) and a second instance 220 (e.g., a second time stamp or time step). First instance 210 and second instance 220 include representations of detected objects, such as cuboid 212 and cuboid 214, positioned in virtual space surrounding vehicle 100. First instance 210 depicts the cuboid representations at one time stamp while second instance 220 depicts the cuboid representations at another time stamp, such as the next time step of output from vision-based machine learning model engine 126. First instance 210 and second instance 220 can be compiled, or aggregated, with other instances (not shown) to compile a set of sequential entries. The representations of detected objects can be assigned unique identifiers that are tracked in the sequential entries.

As may be appreciated, any of the illustrated cuboids can be erroneous. For example, cuboid 212 may not correspond to a physical object. Either first instance 210 or second instance 220 may not have cuboid representations for all physical objects within a desired range of vehicle 100. For example, first instance 210 does not include cuboid 222 which may correspond to a physical object within the desired range of vehicle 100. As discussed above, tracking engine 202 can apply thresholds to object information 124 to filter out erroneous data. For example, cuboid 212 may only be detected in one entry of the set of sequential entries and filtered out. As another example, cuboid 222 may be detected in every entry of the set of sequential entries but first instance 210 and output as a tracked object 204.

FIG. 3 is a block diagram illustrating an example process for applying a vulnerable road user (VRU) network to image information. In the illustrated example, image information 320 is being received by the vision-based machine learning model engine 126 executing a VRU network 310. The VRU network 310 may be used to determine information associated with pedestrians or other vulnerable objects (e.g., baby strollers, skateboarders, and so on). The vision-based machine learning model engine 126 maps information included in the image information 320 into a virtual camera space. For example, a projection view (e.g., a panoramic projection) 322 is included in FIG. 3. Projection view 322 can include one or more representations of detected objects.

FIG. 4 is a block diagram illustrating an example process for applying a non-VRU network to image information. In the illustrated example, image information 420 is being received by the vision-based machine learning model engine 126 executing a non-VRU network 410. The non-VRU network 410 may be trained to focus on, for example, vehicles which are depicted in images obtained from image sensors positioned about an autonomous vehicle. The vision-based machine learning model engine 126 maps information included in the image information 420 into a virtual camera space. For example, a projection view (e.g., a periscope projection) 422 is included in FIG. 4. Projection view 422 can include one or more representations of detected objects.

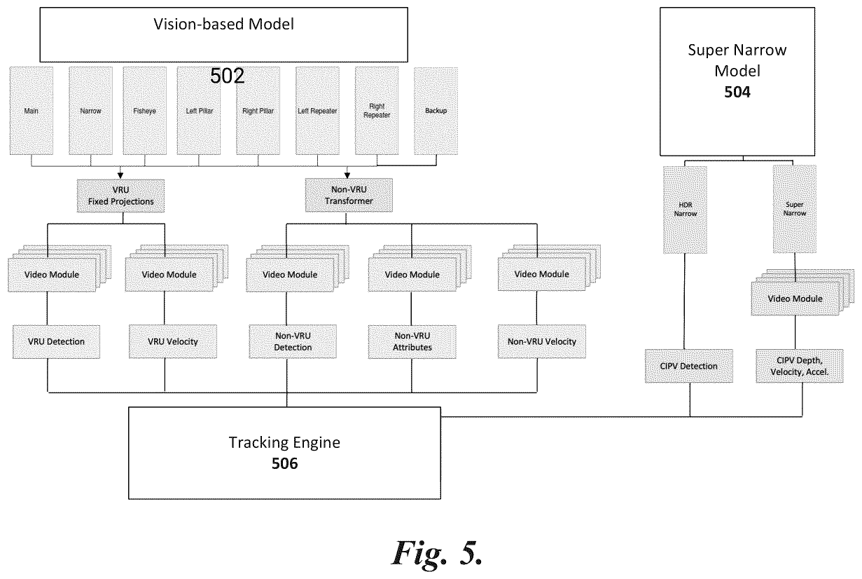

FIG. 5 is a block diagram of the example vision-based machine learning model 502 used in combination with a super narrow machine learning model 504. The super narrow machine learning model 504 may use information from one or more of the front image sensors. Similar to the vision-based model 502, the super narrow model 504 may identify objects, determine velocities of objects, and so on. To determine velocity, in some embodiments time stamps associated with image frames may be used by the model 504. For example, the time stamps may be encoded for use by a portion of the model 504. As another example, the time stamps, or encodings thereof, may be combined or concatenated with tensor(s) associated with the input images (e.g., feature map). Optionally, kinematic information may be used. In this way, the model 504 may learn to determine velocity and/or acceleration.

The super narrow machine learning model 504 may be used to determine information associated with objects within a particular distance of the autonomous vehicle. For example, the model 504 may be used to determine information associated with a closest in path vehicle (CIPV). In this example, the CIPV may represent a vehicle which is in front of the autonomous vehicle. The CIPV may also represent vehicles which are to a left and/or right of the autonomous vehicle. As illustrated, the model 504 may include two portions with a first portion being associated with CIPV detection. The second portion may also be associated with CIPV depth, acceleration, velocity, and so on. In some embodiments, the second portion may use one or more video modules. The video module may obtain 12 frames spread substantially equally over the prior 6 seconds. In some embodiments, the first portion may also use a video module. The super narrow machine learning model 504 can output one or more representations of detected objects.

Optionally, the output of these models may be combined or compared. For example, the super narrow model may be used for objects (e.g., non-VRU objects) traveling in a same direction which are within a threshold distance of the autonomous vehicle described herein. Thus, velocity may be determined by the model 504 for these objects. The combination or comparison may be compiled into object information and fed into tracking engine 506. The object information can also include detected objects from either vision-based model 502 or machine learning model 504 individually.

Tracking engine 506 may apply thresholds on detected objects in the object information. For example, tracking engine 506 can apply thresholds to remove one or more detected objects from the object information. Further, tracking engine 506 may apply thresholds on determined attributes of the detected objects in the object information. Examples of the process of applying thresholds is described below, with respect to FIG. 6.

### Example Flowchart

Turning now to FIG. 6, a routine 600 for applying thresholds to object information will be described. Routine 600 is illustratively implemented by a vehicle, such as vehicle 100, for the purpose of detecting objects and generating attributes of a detected object.

At block 602, the vehicle obtains or is otherwise configured with one or more processing thresholds. As previously described, individual thresholds can be specified as a comparison of the total number of “positive” object detections over a set of sequential entries in the object information. The thresholds can be specified as a comparison of the total number of “negative” object detections over the set of sequential entries in the object information. Additionally, the thresholds can be a requirement that the last entry in the set of sequential entries is a “positive” and/or “negative” detection. In some embodiments, the thresholds can include a specification of different levels of confidence if the thresholds are satisfied. The configuration of the thresholds can be static such that vehicles can utilize the same thresholds once configured. In other embodiment, different thresholds can be dynamically selected based on a variety of criteria, including regional criteria, weather or environmental criteria, manufacturer preferences, user preferences, equipment configuration (e.g., different camera configurations), and the like.

In some embodiments, the vehicle obtains multiple thresholds. For example, different thresholds can be obtained for use with potential detected objects associated with vulnerable road users (VRUs) than are obtained for use with potential detected objects associated with non-VRUs.

At block 604, the vehicle obtains and processes the images from the vision system. If camera inputs are combined for composite or collective images, the vehicle and/or other processing component can provide the additional processing. Other types of processing including error or anomaly analysis, normalization, extrapolation, etc. may also be applied. At block 606, individual processing of the camera inputs (individually or collectively) generates a result of detection of an object or no detection of an object. For example, the camera inputs can be processed by vision-based machine learning model engine 126. The vehicle may process the vision system for VRU and non-VRU networks separately, such as illustrated in FIGS. 3 and 4.

At block 608, such determination may be stored as object information. As described above, the object information is configured as a set of sequential entries, based on time, as to the result of the processing of the image data to make such a determination. The number of sequential entries can be finite in length, such as a moving window of the most recent number of determinations. In one embodiment, during operation, the vision system provides inputs to the machine learning model on a fixed time frame, e.g., every x seconds. Accordingly, in such embodiments, each sequential entry can correspond to a time of capture of image data. Additionally, the finite length can be set to a minimum amount of time (e.g., a number of seconds) determined to have confidence to detect an object using vision data.

At block 610, thresholds are applied to the object information. For example, tracking engine 202 can apply thresholds to the object information. After each detection result, the object information can be compared against thresholds to determine whether the sequence of entries can be characterized as confirming detection of a new object. After each detection result, the object information can be compared against thresholds to determine whether a previously tracked object is no longer present. Multiple thresholds can be included. The use of a particular threshold can depend on one or more features derived in the processing of the images. For example, a different thresholds can be applied to potential detected objects associated with vulnerable road users (VRUs) than potential detected objects associated with non-s.

If the thresholds are not met, the routine 600 can return to block 604 to continue collecting data and updating the object information.

At block 612, if the thresholds are met for a new detected object, the vehicle can classify and track the detected object. The vehicle can then utilize the tracked objects in downstream processes, such as by a planning engine in an autonomous driving system, to make decisions based on tracked object attributes, such as position, rotation, velocity, acceleration, etc. If the thresholds are met to determine a previously tracked object is no longer present, the vehicle can remove the tracked object. Additionally, the vision system can provide the confidence values/categories with the determined detection. At block 614, the routine 600 terminates.

In some embodiments, the use of thresholds can be further used on the different attributes of the tracked objects. The thresholds can be used on the attributes in a similar manner as was performed on the object information. The use of thresholds on attributes can help prevent sudden erroneous changes in that attributes. For example, the use of thresholds may help prevent a car object from suddenly being classified as a minivan object. The thresholds can be specified as a total number of consecutive recorded instances of an attribute required for the attribute to be assigned to the tracked object. For example, the thresholds can require four consecutive classifications that the car object is a minivan before the system updates the classification (e.g., for downstream processes) to be a minivan.

### Block Diagrams—Vehicle Processing Components

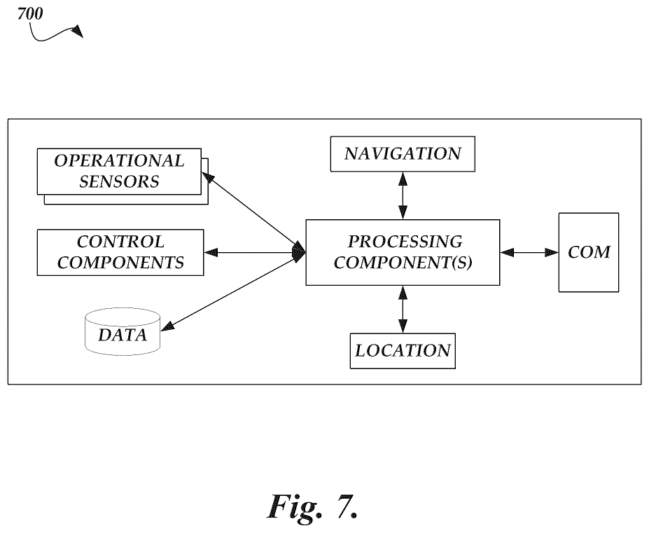

For purposes of illustration, FIG. 7 illustrates an environment 700 that corresponds to vehicles 100 that are representative of vehicles that utilize vision-only detection systems and processing in accordance with one or more aspects of the present application. The environment 700 includes a collection of local sensor inputs that can provide inputs for the operation of the vehicle or collection of information as described herein. The collection of local sensors can include one or more sensor or sensor-based systems included with a vehicle or otherwise accessible by a vehicle during operation. The local sensors or sensor systems may be integrated into the vehicle. Alternatively, the local sensors or sensor systems may be provided by interfaces associated with a vehicle, such as physical connections, wireless connections, or a combination thereof.

In one aspect, the local sensors can include vision systems that provide inputs to the vehicle, such as detection of objects, attributes of detected objects (e.g., position, velocity, acceleration), presence of environment conditions (e.g., snow, rain, ice, fog, smoke, etc.), and the like, such as the vision system described in FIG. 1A. As previously described, vehicles 100 will rely on such vision systems for defined vehicle operational functions without assistance from or in place of other traditional detection systems.

In yet another aspect, the local sensors can include one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes including self-driving applications, enhanced driving or user-assisted navigation, and the like. Illustratively, the positioning systems can include processing components and data that facilitate the identification of various vehicle parameters or process information.

In still another aspect, the local sensors can include one or more navigations system for identifying navigation related information. Illustratively, the navigation systems can obtain positioning information from positioning systems and identify characteristics or information about the identified location, such as elevation, road grade, etc. The navigation systems can also identify suggested or intended lane location in a multi-lane road based on directions that are being provided or anticipated for a vehicle user. Similar to the location systems, the navigation system may be configured as part of a vehicle for multiple purposes including self-driving applications, enhanced driving or user-assisted navigation, and the like. The navigation systems may be combined or integrated with positioning systems. Illustratively, the positioning systems can include processing components and data that facilitate the identification of various vehicle parameters or process information.

The local resources further include one or more processing component(s) that may be hosted on the vehicle or a computing device accessible by a vehicle (e.g., a mobile computing device). The processing component(s) can illustratively access inputs from various local sensors or sensor systems and process the inputted data as described herein. For purposes of the present application, the processing component(s) are described with regard to one or more functions related to illustrative aspects. For example, processing component(s) in vehicles 100 will collect and transmit the first and second data sets.

The environment 700 can further include various additional sensor components or sensing systems operable to provide information regarding various operational parameters for use in accordance with one or more of the operational states. The environment 700 can further include one or more control components for processing outputs, such as transmission of data through a communications output, generation of data in memory, transmission of outputs to other processing components, and the like.

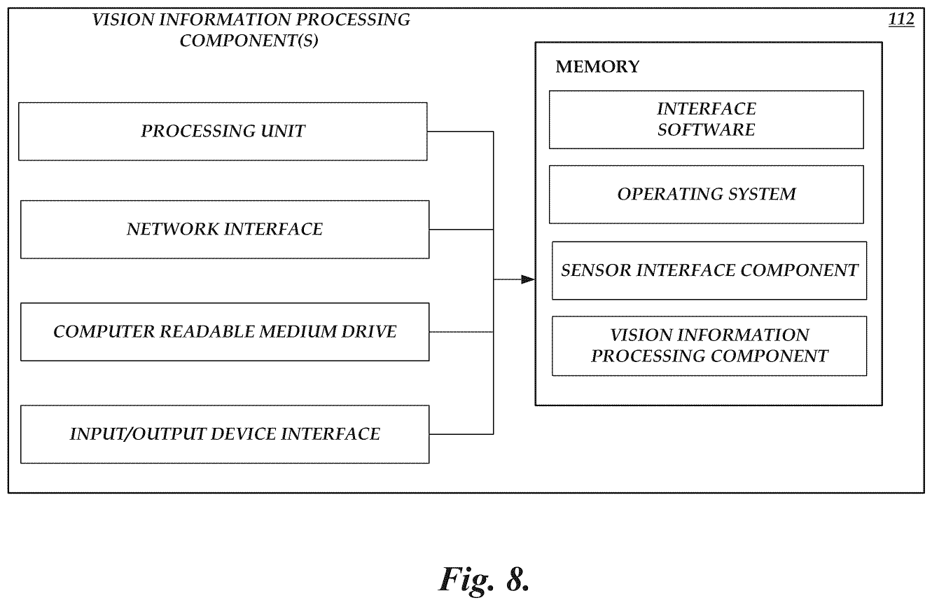

With reference now to FIG. 8, an illustrative architecture for implementing the vision information processing components 112 on one or more local resources or a network service will be described. The vision information processing components 112 may be part of components/systems that provide functionality associated with the operation of headlight components, suspension components, etc. In other embodiments, the vision information processing components 112 may be a stand-alone application that interacts with other components, such as a local sensors or sensor systems, signal interfaces, etc.

The architecture of FIG. 8 is illustrative in nature and should not be construed as requiring any specific hardware or software configuration for the vision information processing components 112. The general architecture of the vision information processing components 112 depicted in FIG. 8 includes an arrangement of computer hardware and software components that may be used to implement aspects of the present disclosure. As illustrated, the vision information processing components 112 includes a processing unit, a network interface, a computer readable medium drive, and an input/output device interface, all of which may communicate with one another by way of a communication bus. The components of the vision information processing components 112 may be physical hardware components or implemented in a virtualized environment.

The network interface may provide connectivity to one or more networks or computing systems. The processing unit may thus receive information and instructions from other computing systems or services via a network. The processing unit may also communicate to and from memory and further provide output information for an optional display via the input/output device interface. In some embodiments, the vision information processing components 112 may include more (or fewer) components than those shown in FIG. 8, such as implemented in a mobile device or vehicle.

The memory may include computer program instructions that the processing unit executes in order to implement one or more embodiments. The memory generally includes RAM, ROM, or other persistent or non-transitory memory. The memory may store an operating system that provides computer program instructions for use by the processing unit in the general administration and operation of the vision information processing components 112. The memory may further include computer program instructions and other information for implementing aspects of the present disclosure. For example, in one embodiment, the memory includes a sensor interface component that obtains information from the various sensor components, including the vision system of vehicle 100.

The memory further includes a vision information processing component for obtaining and processing the collected vision information and processing according to one or more thresholds as described herein. Although illustrated as components combined within the vision information processing components 112, one skilled in the relevant art will understand that one or more of the components in memory may be implemented in individualized computing environments, including both physical and virtualized computing environments.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A method for processing inputs in a vision-only systems comprising:
obtaining a set of data corresponding to operation of a vehicle, wherein the set of data includes a set of images corresponding to a vision system;
processing individual image data from the set of images to determine whether object detection is depicted in the individual image data;
updating object information corresponding to a sequence of processing results based on the processing of the individual image data;
determining whether the updated object information satisfies at least one threshold; and
identifying a detected object and associated object attributes based on the determination that the updated object information satisfies the at least one threshold.

2. The method of claim 1, wherein the sequence of processing results comprises a set of sequential entries based on time, and each entry of the set of sequential entries includes at least an indication of an object detection.

3. The method of claim 2, wherein determining whether the updated object information satisfies the at least one threshold comprises determining whether a total number of object detections in the set of sequential entries exceeds a threshold value.

4. The method of claim 3, wherein the threshold value is determined based on a level of confidence.

5. The method of claim 3, wherein the threshold value is dynamically determined based on a fidelity of the set of images.

6. The method of claim 2, wherein determining whether the updated object information satisfies the at least one threshold comprises determining whether a last entry in the set of sequential entries indicates an object detection.

7. The method of claim 1, wherein the individual image data includes one or more combined images from two or more camera images of the vision system.

8. A system comprising one or more processors and non-transitory computer storage media storing instructions that when executed by the one or more processors, cause the processors to perform operations, wherein the system is included in an autonomous or semi-autonomous vehicle, and wherein the operations comprise:
obtaining a set of data corresponding to operation of a vehicle, wherein the set of data includes a set of images corresponding to a vision system;
processing individual image data from the set of images to determine whether object detection is depicted in the individual image data;
updating object information corresponding to a sequence of processing results based on the processing of the individual image data;
determining whether the updated object information satisfies at least one threshold; and
identifying a detected object and associated object attributes based on the determination that the updated object information satisfies the at least one threshold.

9. The system of claim 8, wherein the sequence of processing results comprises a set of sequential entries based on time, and each entry of the set of sequential entries includes at least an indication of an object detection.

10. The system of claim 9, wherein determining whether the updated object information satisfies the at least one threshold comprises determining whether a total number of object detections in the set of sequential entries exceeds a threshold value.

11. The system of claim 10, wherein the threshold value is determined based on a level of confidence.

12. The system of claim 10, wherein the threshold value is dynamically determined based on a fidelity of the set of images.

13. The system of claim 9, wherein determining whether the updated object information satisfies the at least one threshold comprises determining whether a last entry in the set of sequential entries indicates an object detection.

14. The system of claim 8, wherein the individual image data includes one or more combined images from two or more camera images of the vision system.

15. Non-transitory computer storage media storing instructions that when executed by a system of one or more processors which are included in an autonomous or semi-autonomous vehicle, cause the system to perform operations comprising:
obtaining a set of data corresponding to operation of a vehicle, wherein the set of data includes a set of images corresponding to a vision system;
processing individual image data from the set of images to determine whether object detection is depicted in the individual image data;
updating object information corresponding to a sequence of processing results based on the processing of the individual image data;
determining whether the updated object information satisfies at least one threshold; and
identifying a detected object and associated object attributes based on the determination that the updated object information satisfies the at least one threshold.

16. The computer storage media of claim 15, wherein the sequence of processing results comprises a set of sequential entries based on time, and each entry of the set of sequential entries includes at least an indication of an object detection.

17. The computer storage media of claim 16, wherein determining whether the updated object information satisfies the at least one threshold comprises determining whether a total number of object detections in the set of sequential entries exceeds a threshold value.

18. The computer storage media of claim 17, wherein the threshold value is dynamically determined based on a fidelity of the set of images.

19. The computer storage media of claim 16, wherein determining whether the updated object information satisfies the at least one threshold comprises determining whether a last entry in the set of sequential entries indicates an object detection.

20. The computer storage media of claim 15, wherein the individual image data includes one or more combined images from two or more camera images of the vision system.

21. (canceled)
